(19) United States
(12) Patent Application Publication
(10) Pub. No.: US 2015/0316446 A1
(43) Pub. Date: Nov. 5, 2015

(54) ENGINE RPM SIGNAL PROCESSING METHOD FOR CLUTCH CONTROL IN VEHICLE

(71) Applicants: Hyundai Motor Company, Seoul (KR); Kia Motors Corp., Seoul (KR)

(72) Inventor: Jin Sung KIM, Seoul (KR)

(73) Assignees: Hyundai Motor Company, Seoul (KR); Kia Motors Corp., Seoul (KR)

(21) Appl. No.: 14/561,104

(22) Filed: Dec. 4, 2014

(30) Foreign Application Priority Data
May 2, 2014 (KR) 10-2014-0053220

(51) Int. Cl. G01M 15/04; G01P 3/489

(52) U.S. Cl. CPC G01M 15/046; G01P 3/489

(57) ABSTRACT

An engine rpm signal processing method in a vehicle, may include a low speed determination step for determining whether an engine rpm sensor signal needs to be subjected to post processing when the engine rpm sensor signal is less than a predetermined first reference speed, and a filtering step for processing the engine rpm sensor signal with a Kalman filter to output a filtered engine rpm when it is determined in the low speed determination step that the post processing of the engine rpm sensor signal is necessary.

### CROSS REFERENCE TO RELATED APPLICATION

The present application claims priority to Korean Patent Application Number 10-2014-0053220 filed May 2, 2014, the entire contents of which is incorporated herein for all purposes by this reference.

### BACKGROUND OF THE INVENTION

1. Field of the Invention

The present invention relates, generally, to an engine rpm signal processing method in a vehicle and, more particularly, to an engine rpm signal processing method for controls including a clutch control used in a dual clutch transmission (DCT) on a vehicle.

2. Description of Related Art

These days a dual clutch transmission (DCT) is actively being developed to provide the driver with both the convenience of an automatic transmission and the fuel-efficiency and power efficiency of a manual transmission. The DCT, an automated manual automotive transmission, has two torque transmitting shafts and controls the clutch automatically without a torque converter. Such a DCT is fuel-efficient.

However, a DCT system featuring a dry clutch, engages the clutch directly without a torque converter, thus the clutch control performance has an effect on take-off performance and transmission performance of the vehicle.

The DCT monitors engine torque, engine speed, etc. and operates a feedback control to control the clutch for direct connection without the torque converter. Specifically, an oscillation control to process starting of the vehicle equipped with a dry clutch, uses the engine rpm signal directly to control the clutch with the variation in the engine rpm.

However, because the engine rpm signal uses a signal of a sensor on the engine crankshaft, it has low resolution in a low speed region. Thus, because of low accuracy of the engine rpm in this region, there are difficulties in designing associated controllers for the clutch controlling, the clutch torque estimate, and the like. Consequently, in this region, signal processing is important to increase reliability.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine rpm signal processing method in a vehicle to effectively use information about the engine rpm even in a low speed region. In other words, the method properly processes the signal from a sensor intended to measure the engine rpm in the low speed region of the engine, and thus increases reliability of the information about the engine rpm.

According to various aspects of the present invention, an engine rpm signal processing method in a vehicle may include a low speed determination step for determining whether an engine rpm sensor signal needs to be subjected to post processing when the engine rpm sensor signal is less than a predetermined first reference speed, and a filtering step for processing the engine rpm sensor signal with a Kalman filter to output a filtered engine rpm when it is determined in the low speed determination step that the post processing of the engine rpm sensor signal is necessary.

It may be determined in the low speed determination step that the post processing of the engine rpm sensor signal is unnecessary when the engine rpm has been more than a predetermined second reference speed for a predetermined reference duration or longer, the predetermined second reference speed being higher than the first reference speed.

The engine rpm signal processing method in the vehicle may further include a variation limiting step for limiting variation in the engine rpm, provided to the filtering step, to a range defined by a predetermined reference increment and a predetermined reference decrement by processing the engine rpm sensor signal that is provided to the filtering step when it is determined in the low speed determination step that the post processing of the engine rpm sensor signal is necessary.

The variation limiting step may be carried out by providing, as an engine rpm signal, a greater value amongst an engine rpm calculated in a previous cycle, minus the reference decrement, and a signal from the engine rpm sensor, or a smaller value amongst the engine rpm calculated in the previous cycle, plus the reference increment, and a signal from the engine rpm sensor to the filtering step.

The engine rpm sensor signal may be processed with a Kalman filter in the filtering step in accordance with the following formulas:

Predicted estimate of state variables: {circumflex over ( x̅_{[k]}=G x̅_{[k-1]}+Hu_{[k-1]}, Predicted estimate covariance: P̅_{[k]}=GP_{[k-1]}G^{T}+Q, Kalman gain: K_{[k]}= P̅_{[k]}C^{T}(C P̅_{[k]}C^{T}+R)⁻¹, State estimate: \hat{x}_{[k]}={circumflex over ( x̅_{[k]}+K_{[k]}(y_{[k]}−C{circumflex over ( x̅_{[k]}), Estimate covariance: P_{[k]}=(1−K_{[k]}C) P̅_{[k]}, in which the state variables are an engine angular velocity ωₑ, and an engine angular acceleration \dot{ω}ₑ, satisfying the following:

$$x = [ \begin{matrix}{ω}_{e} \\ {\dot{ω}}_{e}\end{matrix} ]$$

and u=ωₑ, y_{[k]}=[1 0]\hat{x}_{[k]}+z_{[k]},

$$H = [ \begin{matrix}{T}_{s}^{2} / 2 \\ {T}_{s}\end{matrix} ] , G = [ \begin{matrix}1 & {T}_{s} \\ 0 & 1\end{matrix} ] , Q = [ \begin{matrix}{Q}_{1} & 0 \\ 0 & {Q}_{2}\end{matrix} ] ,$$

C=[1 0], in where z is a signal from the engine rpm sensor, Tₛ is sampling time of the engine rpm signal, Q₁ and Q₂ are relatively set values according to reliability of the engine angular velocity and the engine angular acceleration, and R, which is used in the Kalman gain formula, is a value for dampening noise of the engine rpm sensor and a 1×1 scalar constant value determined after determining Q₁ and Q₂.

The Q₁ may be set to be less than the Q₂ when the engine angular velocity is higher in reliability than the engine angular acceleration, and the Q₂ may be set to be lower than the Q₁ when the engine angular acceleration is higher in reliability than the engine angular velocity.

This invention makes it possible to effectively use information about engine rpm in a low speed region of the engine by properly processing a signal from a sensor intended to measure the engine rpm in the low speed region and increasing reliability of the information about the engine rpm.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flow diagram to illustrate an exemplary engine rpm signal processing method in a vehicle according to the present invention.

FIG. 2 is a graph to illustrate an effect of the exemplary engine rpm signal processing method in the vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

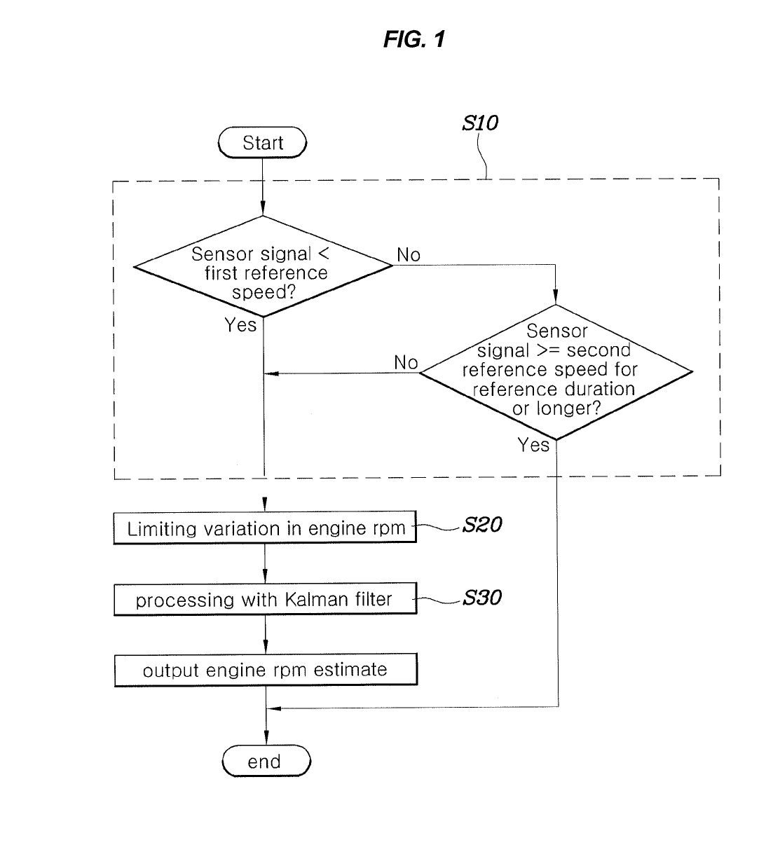

Referring to FIG. 1, an engine rpm signal processing method in a vehicle according to various embodiments of the present invention includes, a low speed determination step (S10) for determining whether an engine rpm sensor signal needs to be subjected to post processing when the engine rpm sensor signal is less than a predetermined first reference speed, and a filtering step (S30) for processing the engine rpm sensor signal with a Kalman filter to output a filtered engine rpm when it is determined in the low speed determination step that the post processing of the engine rpm sensor signal is necessary.

In other words, this method operates the post processing of the output signal from the engine rpm sensor with a Kalman filter in a region where the engine rpm sensor signal has low resolution and then uses the signal as the engine rpm signal for various controls including clutch controlling.

Consequently, it is desirable to set the first reference speed at a level in which it is possible to differentiate the reliability of the signals according to whether the post processing of the engine rpm sensor signal is operated or not. Thus, it is mostly set near the idle speed of the engine.

In the low speed determination step, it is determined that the post processing of the engine rpm sensor signal is unnecessary if the engine rpm has been more than a predetermined second reference speed for a predetermined reference duration or longer, the predetermined second reference speed being higher than the first reference speed.

The above is intended to prevent the repetition of entry into and exit from the filtering step when the engine rpm oscillates near the first reference speed, and to secure stable operability. Thus, the second reference speed is properly set higher than the first reference speed through many experiments to accord with the above object, and the reference duration is also properly set in a range of dozens of milliseconds to accord with the same object.

Various embodiments further include a variation limiting step (S20) for limiting variation in the engine rpm to a range defined by a predetermined reference increment and a predetermined reference decrement by processing the engine rpm sensor signal that is to be provided to the filtering step when it is determined in the low speed determination step that the post processing of the engine rpm sensor signal is necessary.

The variation limiting step (S20) is carried out by providing, as an engine rpm signal, a greater value amongst an engine rpm calculated in a previous cycle, minus the reference decrement, and a signal from the engine rpm sensor, or a smaller value amongst an engine rpm calculated in a previous cycle, plus the reference increment, and a signal from the engine rpm sensor to the filtering step.

In other words, in the variation limiting step (S20), when there is a sudden change in the engine rpm sensor signal, the engine rpm sensor signal is not used for the filtering step directly. Instead, if the engine rpm sensor signal is in a range defined by the reference increment and the reference decrement, it is used for the filtering step, but if the engine rpm sensor signal is less than the value obtained by subtracting the reference decrement from the engine rpm calculated in the previous cycle, the value is used as the engine rpm signal that is to be provided to the filtering step. Also if the engine rpm sensor signal is more than the value obtained by adding the reference increment to the engine rpm calculated in the previous cycle, the value is used as the engine rpm signal that is to be provided to the filtering step.

Consequently, the rpm sensor signal with a sudden change is filtered already before the filtering step by the variation limiting step (S20).

In other words, when it is determined in the low speed determination step that the post processing of the engine rpm sensor signal is necessary, the filtering step is operated after the variation limiting step as in previously described embodiments. Unlike the previously described embodiments, though it is determined in the low speed determination step that the post processing of the engine rpm sensor signal is unnecessary, it is available to operate the variation limiting step and get smooth engine rpm variation.

The engine rpm sensor signal is processed with a Kalman filter in the filtering step (S30) in accordance with the following formulas:

Predicted estimate of state variables: {circumflex over ( x̅_{[k]}=G x̅_{[k-1]}+Hu_{[k-1]}, Predicted estimate covariance: P̅_{[k]}=GP_{[k-1]}G^{T}+Q, Kalman gain: K_{[k]}= P̅_{[k]}C^{T}(C P̅_{[k]}C^{T}+R)⁻¹, State estimate: \hat{x}_{[k]}={circumflex over ( x̅_{[k]}+K_{[k]}(y_{[k]}−C{circumflex over ( x̅_{[k]}), Estimate covariance: P_{[k]}=(1−K_{[k]}C) P̅_{[k]}, in which the state variables are an engine angular velocity ωₑ, and an engine angular acceleration \dot{ω}ₑ, satisfying the following:

$$x = [ \begin{matrix}{ω}_{e} \\ {\dot{ω}}_{e}\end{matrix} ]$$

and u=ωₑ, y_{[k]}=[1 0]\hat{x}_{[k]}+z_{[k]},

$$H = [ \begin{matrix}{T}_{s}^{2} / 2 \\ {T}_{s}\end{matrix} ] , G = [ \begin{matrix}1 & {T}_{s} \\ 0 & 1\end{matrix} ] , Q = [ \begin{matrix}{Q}_{1} & 0 \\ 0 & {Q}_{2}\end{matrix} ] ,$$

C=[1 0], in which z is a signal from the engine rpm sensor, Tₛ is sampling time of the engine rpm signal, Q₁ and Q₂ are the relatively set values according to the reliability of the engine angular velocity and the engine angular acceleration, and C is a 1×2 vector because only the engine angular velocity can be measured practically.

Also, R, which is used in the Kalman gain formula, is the value for dampening the noise of the engine rpm sensor, the 1×1 scalar constant value determined after determining Q₁ and Q₂, and can be tuned to correspond to the result by increasing R gradually.

If the engine angular velocity is higher in reliability than the engine angular acceleration, Q₁ is set to be less than Q₂. On the other hand, if the engine angular acceleration is higher in reliability than the engine angular velocity, Q₂ is set to be less than Q₁.

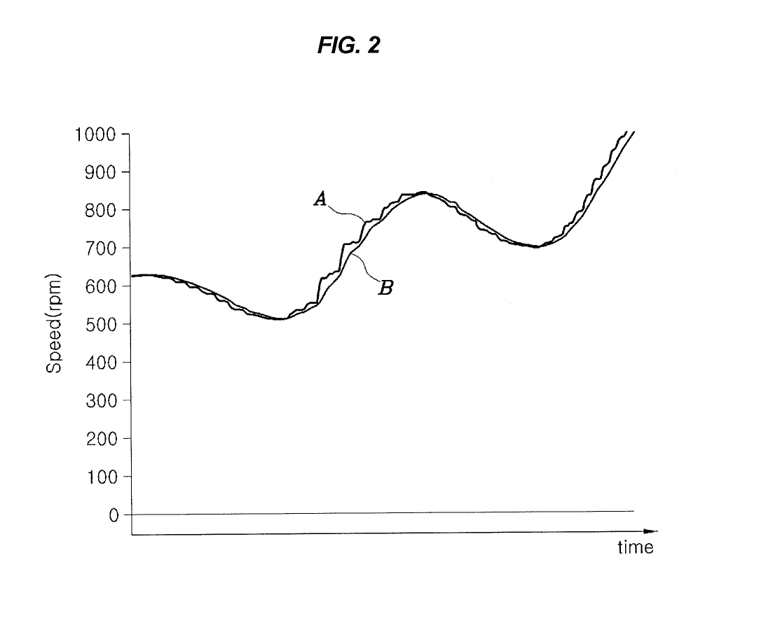

The signal of the engine rpm passing through the filtering step has a smooth curve shape without a highly variable oscillation and conforms with the measured signal as illustrated in FIG. 2. Thus, it can be used for various controls including clutch controlling of the vehicle and to increase the stability and reliability of the control.

In addition, FIG. 2 illustrates the engine rpm sensor signal A compared with the processed signal B by the present invention in which the stall of the engine is predicted while a vehicle is moved in creep travel.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine rpm signal processing method in a vehicle, comprising:
a low speed determination step for determining whether an engine rpm sensor signal needs to be subjected to post processing when the engine rpm sensor signal is less than a predetermined first reference speed; and
a filtering step for processing the engine rpm sensor signal with a Kalman filter to output a filtered engine rpm when it is determined in the low speed determination step that the post processing of the engine rpm sensor signal is necessary.

2. The method of claim 1, wherein it is determined in the low speed determination step that the post processing of the engine rpm sensor signal is unnecessary when the engine rpm has been more than a predetermined second reference speed for a predetermined reference duration or longer, the predetermined second reference speed being higher than the first reference speed.

3. The method of claim 1, further comprising:
a variation limiting step for limiting variation in the engine rpm, provided to the filtering step, to a range defined by a predetermined reference increment and a predetermined reference decrement by processing the engine rpm sensor signal that is provided to the filtering step when it is determined in the low speed determination step that the post processing of the engine rpm sensor signal is necessary.

4. The method of claim 3, wherein the variation limiting step is carried out by providing, as an engine rpm signal, a greater value amongst an engine rpm calculated in a previous cycle, minus the reference decrement, and a signal from the engine rpm sensor, or a smaller value amongst the engine rpm calculated in the previous cycle, plus the reference increment, and a signal from the engine rpm sensor to the filtering step.

5. The method of claim 1, wherein the engine rpm sensor signal is processed with a Kalman filter in the filtering step in accordance with the following formulas:
Predicted estimate of state variables {circumflex over ( x̅_{[k]}=G x̅_{[k-1]}+Hu_{[k-1]},
Predicted estimate covariance P̅_{[k]}=GP_{[k-1]}G^{T}+Q,
Kalman gain K_{[k]}= P̅_{[k]}C^{T}(C P̅_{[k]}C^{T}+R)⁻¹,
State estimate \hat{x}_{[k]}={circumflex over ( x̅_{[k]}+K_{[k]}(y_{[k]}−C{circumflex over ( x̅_{[k]}),
Estimate covariance P_{[k]}=(1−K_{[k]}C) P̅_{[k]}.
wherein the state variables are an engine angular velocity ωₑ, and an engine angular acceleration \dot{ω}ₑ, satisfying the following:
$$x = [ \begin{matrix}{ω}_{e} \\ {\dot{ω}}_{e}\end{matrix} ]$$
and u=ωₑ,
y_{[k]}=[1 0]\hat{x}_{[k]}+z_{[k]},
$$H = [ \begin{matrix}{T}_{s}^{2} / 2 \\ {T}_{s}\end{matrix} ] , G = [ \begin{matrix}1 & {T}_{s} \\ 0 & 1\end{matrix} ] , Q = [ \begin{matrix}{Q}_{1} & 0 \\ 0 & {Q}_{2}\end{matrix} ] ,$$
C=[1 0],
wherein z is a signal from the engine rpm sensor,
Tₛ is sampling time of the engine rpm signal,
Q₁ and Q₂ are relatively set values according to reliability of the engine angular velocity and the engine angular acceleration, and
R, which is used in the Kalman gain formula, is a value for dampening noise of the engine rpm sensor and a 1×1 scalar constant value determined after determining Q₁ and Q₂.

6. The method of claim 5, wherein the Q₁ is set to be less than the Q₂ when the engine angular velocity is higher in reliability than the engine angular acceleration, and the Q₂ is set to be lower than the Q₁ when the engine angular acceleration is higher in reliability than the engine angular velocity.
